(19) United States
(12) Patent Application Publication
(10) Pub. No.: US 2005/0118986 A1
(43) Pub. Date: Jun. 2, 2005

(54) Phone number and name pronunciation interchange via cell phone

(75) Inventors: William Barton, Boston, MA (US); Jordan Cohen, Gloucester, MA (US)

Correspondence Address: WILMER CUTLER PICKERING HALE AND DORR LLP, 60 STATE STREET, BOSTON, MA, 02109, US

(73) Assignee: Voice Signal Technologies, Inc.

(21) Appl. No.: 10/937,890

(22) Filed: Sep. 9, 2004

Related U.S. Application Data
(60) Provisional application No. 60/501,972, filed on Sep. 11, 2003.

(51) Int. Cl. H04M 1/00

(52) U.S. Cl. 455/412.1; 455/466

(57) ABSTRACT

A method of transferring phone book information from one cell phone to another cell phone includes compiling the phone book information relating to one or more cell phone users into a data transmission package, and sending the data transmission package from the first cell phone to the second cell phone, via a communication channel native to the first and second cell phones.

### CROSS-REFERENCE TO RELATED APPLICATIONS

This application claims benefit U.S. Provisional Patent Application Ser. No. 60/501,972, filed Sep. 11, 2003.

### TECHNICAL FIELD

This invention relates generally to wireless communication devices.

### BACKGROUND

Wireless communications devices, such as cellular telephones (cell phones), commonly employ a phone book for storing contact information (e.g., names, numbers and other information) related to frequently called parties. The phone book is typically a database that is accessible through a keypad input, or via spoken commands that are processed by a speech recognizer.

The phonebook typically consists of an ordered structure of records, each of which is associated with one of the frequently called parties. Each record includes the name of the party, his phone number, and various other data associated with the party. The other data typically varies according to the make and model of the cell phone, and may include for example street address, e-mail address, fax number, name pronunciation information (e.g., phonetic representations, acoustic parameters, compressed audio, etc.), and general personal information.

A user places a call to a party in the phone book by entering the name of the party into the cell phone, either by manual entering the name through the keypad, or by uttering the name. The cell phone accesses the appropriate record, displays some or all of the information in the record, and queries the user for a subsequent action (i.e., call the party's phone number?).

A user typically populates the phone book by manually entering information for individual parties, or by downloading information for one or more parties from a computer (or other similar device) via a cable and/or a dedicated interface port. Both of these techniques can be cumbersome and time-consuming. Further, populating the phone book via a computer download is often not feasible when the user is traveling and away from his computing resources.

Some prior art cell phones provide for transferring phone book records directly from one phone to another via an infrared light channel. A disadvantage of this transfer technique is that it requires an unobstructed line of sight from the sending phone to the receiving phone, and the maximum distance allowed between the phones is limited.

### SUMMARY OF THE INVENTION

The described embodiment transfers one or more partial or complete records from a phone book on a cell phone to another cell phone, via the network through which the cell phones communicate.

In one aspect, a method of transferring contact information includes compiling contact information relating to one or more wireless communication transceiver users into a data transmission package, and transferring the data transmission package from a first wireless transceiver to a second wireless communication transceiver, on a communications network channel native to the first and second wireless communication transceivers.

The contact information may be compiled in an SMS message or in an e-mail message, or in other data transfer protocol/services known in the art. The contact information may include one or more phone book records including at least a name and an associated phone number. The second wireless communication transceiver extracts the phone book records and stores the records in its own phone book.

The data transmission package transfer can occur while a first user communicates with a second user via the first wireless communication transceiver and the second wireless communication transceiver, respectively. The transfer can also occur after the communication session is complete.

If the second wireless communication transceiver detects an error condition in the data transmission package, the second wireless communication transceiver responds with an error message.

In another aspect, a computer readable medium with stored instructions adapted for transferring contact information includes instructions for compiling contact information relating to one or more wireless communication transceiver users into a data transmission package, and instructions for transferring the data transmission package from a first wireless transceiver to a second wireless communication transceiver, on a communications network channel native to the first and second wireless communication transceivers.

### BRIEF DESCRIPTION OF THE DRAWINGS

FIG. 1 shows an example of a phone book record;

FIG. 2 shows a high-level block diagram of a smartphone.

### DESCRIPTION OF THE PREFERRED EMBODIMENTS

The described embodiment is a cell phone with embedded phone book functionality (phone book) that allows a user of the cell phone to quickly access frequently called parties. Embedded application software in the cellular telephone implements the phone book.

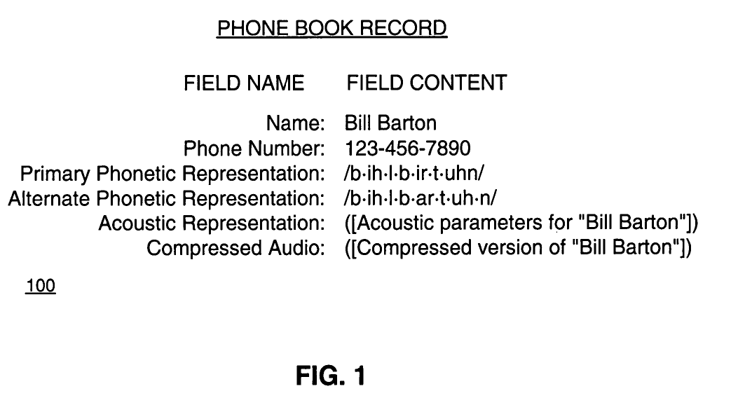

The phone book is a database of records, each record including fields with contact information related to one of the frequently called parties. In the described embodiment, the phone book record fields include (i) name of the party, (ii) the phone number of the party, (iii) a primary phonetic representation of the name of the party, (iv) alternative phonetic representation(s), (v) an acoustic representation, and (vi) a compressed audio representation of the name of the party. This list of related information is merely an example, and other phone books may include more, less or different information. One example of a phone book record 100 is shown in FIG. 1.

A user of the cell phone can populate the phone book with records via techniques known in the art. The user can manually enter a phone book record through the cell phone key pad, responding to cues from the cell phone (e.g., “enter first name,” “enter last name,” etc.). The user can alternatively download records from a computer or other electronic device through a cable and/or a dedicated interface port. This type of transfer typically takes place automatically via a handshaking protocol on the interface after the user initiates the transfer at either the computer or the cell phone.

In the described embodiment, the user can also populate the phone book by transferring phone book records through the same communications channels and services that the cell phone uses to communicate voice and data with other cell phones. Short Message Service (SMS), Long SMS (i.e., concatenated SMS), Enhanced Message Service (EMS) and e-mail are examples of services though which the cell phone can transfer phone book records. In general, the described embodiment may use any data transmission package in any communications channel (and associated service) native to the sending and receiving cell phones, to transfer the phone book records. Communications channels and services that are “native to the sending and receiving cell phones” are those for which the cell phones are designed and manufactured to handle, and for which the cell phones have a sufficient level of service to use.

A phone book record transfer may occur from one cell phone user to another cell phone user as a result of a request by one of the users. For example, a first user may state during a conversation, “Would you like my phone number?” If the second cell phone user responds in the affirmative, the first cell phone user initiates a phone book record transfer to the second cell phone user by requesting a transfer function. The first cell phone user requests the transfer function either by uttering a command for the transfer function, or by manually requesting the transfer function via the cell phone keypad.

The cell phone responds to the request for the transfer function by queuing the transfer to occur some time after the conversation is complete. Some cell phones, however, operate with a level of service that can support SMS communication during a conversation. Those cell phones can respond to the request for the transfer function by executing the record transfer while the conversation between the two users continues.

Regardless of when the phone book record transfer occurs, the sending cell phone (i.e., the cell phone providing the record) responds to the request for the transfer function as follows:
1. The sending cell phone initiates an SMS message to the receiving cell phone.
2. The sending cell phone loads the phone book record fields, appropriately delineated, into the SMS message. The position of the field within the message identifies the field. Alternatively, each field includes a header identifying that field.
3. The sending cell phone adds a header to the SMS message identifying the SMS message as a phone book record.
4. The sending cell phone sends the SMS message to the receiving phone.

The receiving cell phone receives the SMS message and processes the SMS message as follows:
1. The receiving cell phone identifies the SMS message as a phone book record via the header.
2. The receiving cell phone extracts the phone book record fields from the SMS message, and identifies those fields, either by their respective position within the fields, or by associated headers identifying those fields.
3. The receiving phone adds the phone book record fields into its own phone book.

The phone book record fields within the SMS message (or other data transmission protocol) may be deployed in a self-organizing format, such as XML (extensible Markup Language). XML is a well-known transfer language for data, and includes self-describing header information that allows for parsing the conveyed information at the receiving end of the transfer. Using XML (or other similar self-organizing format) reduces or eliminates the need for the sending system and the receiving system to have substantial knowledge of one another. In other words, by using XML (or other similar self-organizing format), the sending system does not need to be cognizant of the receiving system phone book structure, information field sizes, etc., in order to send phone book information.

Receipt of the SMS message can result in an error condition. For example, the header may be corrupted, so that the receiving cell phone cannot identify the SMS message as a phone book record. Or, the information within a particular field may be incompatible with that field (e.g., text in a phone number field, or numbers in a name field). If the receiving cell phone encounters these or other error conditions, the receiving cell phone results in a return SMS message identifying the error condition. The sending cell phone responds to this return SMS message by re-sending the phone book record.

Transferring pronunciation information (i.e., phonetic representations, acoustic representations, and compressed audio) associated with the name of the party in the phone book record improves the accuracy of the name lookup in the receiving cell phone, as compared to only sending name and phone number. Further, transferring the compressed audio allows playback of the name in the voice party sending the phone book record, which will be more readily identified than that of the same name synthesized by phonetic rule.

Although the described embodiment is a cell phone, other wireless communication transceiver devices can also transfer phone book records via existing communications channels. For example, Personal Communication Services (PCS), Enhanced Specialized Mobile Radio (ESMR), or even landline based devices can also transfer phone book records using the techniques described herein.

Information other than phone book records can be transferred using the techniques described herein. For example, records from address books such as those typically found in e-mail applications can be transferred. Fields within these records may include street addresses, personal information, business information, etc.

Although the described embodiment transfers a single record (i.e., information about the cell phone user on one end of the conversation), the techniques described herein can also be used to send multiple records, so as to populate a portion of or an entire phone book. For example, a person upgrading his cell phone can use the techniques described herein to transfer his phone book from his older phone to his newer phone.

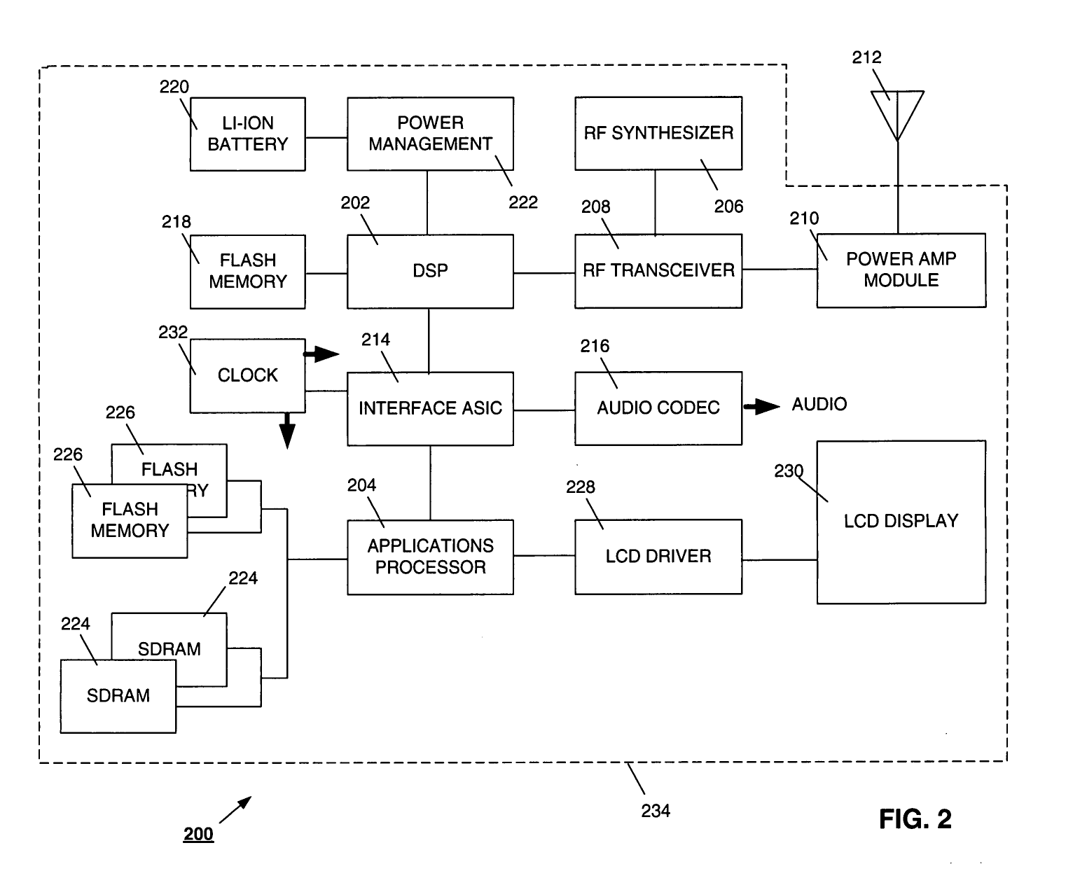

A smartphone 200, as shown in FIG. 2, is a typical platform that can provide such speech recognition functionality via embedded application software. In fact, the described method of transferring phone book records may also be implemented in other portable phones, and in other hand held devices in general.

One example of a smartphone 200 is a Microsoft PocketPC-powered phone which includes at its core a baseband DSP 202 (digital signal processor) for handling the cellular communication functions (including for example voiceband and channel coding functions) and an applications processor 204 (e.g. Intel StrongArm SA-1110) on which the PocketPC operating system runs. The phone supports GSM voice calls, SMS (Short Messaging Service) text messaging, wireless email, and desktop-like web browsing along with more traditional PDA features.

An RF synthesizer 206 and an RF radio transceiver 208, followed by a power amplifier module 210, implement the transmit and receive functions. The power amplifier module handles the final-stage RF transmit duties through an antenna 212. An interface ASIC 214 and an audio CODEC 216 provide interfaces to a speaker, a microphone, and other input/output devices provided in the phone such as a numeric or alphanumeric keypad (not shown) for entering commands and information.

DSP 202 uses a flash memory 218 for code store. A Li-Ion (lithium-ion) battery 220 powers the phone and a power management module 222 coupled to DSP 202 manages power consumption within the phone. SDRAM 224 and flash memory 226 provide volatile and non-volatile memory, respectively, for applications processor 214. This arrangement of memory holds the code for the operating system, the code for customizable features such as the phone directory, and the code for any embedded applications software in the smartphone, including the voice recognition software described above. The visual display device for the smartphone includes LCD driver chip 228 that drives LCD display 230. Clock module 232 provides the clock signals for the other devices within the phone and provides an indicator of real time. All of the above-described components are packages within an appropriately designed housing 234.

Smartphone 200 described above represents the general internal structure of a number of different commercially available smartphones, and the internal circuit design of those phones is generally known in the art.

In the described embodiment, an application running on the applications processor 104 performs the process of transferring phone book records as described herein.

Other aspects, modifications, and embodiments are within the scope of the following claims.

1. A method of transferring contact information, comprising:
compiling contact information relating to one or more wireless communication transceiver users into a data transmission package; and,
transferring the data transmission package from a first wireless transceiver to a second wireless communication transceiver, on a communications network channel native to the first and second wireless communication transceivers.

2. The method of claim 1, further including compiling the contact information into at least one SMS message.

3. The method of claim 1, further including compiling the contact information into at least one e-mail message.

4. The method of claim 1, further including compiling one or more phone book records into the data package, wherein each of the phone book records includes at least a name and an associated phone number.

5. The method of claim 4, further including extracting the one or more phone book records from the data transmission package and storing the one or more phone book records in a phone book in the second wireless communication transceiver.

6. The method of claim 1, further including transferring the data transmission package while a first user communicates with a second user via the first wireless communication transceiver and the second wireless communication transceiver, respectively.

7. The method of claim 1, further including transferring the data transmission package after a communication session between a first user and a second user of the first wireless communication transceiver and the second wireless communication transceiver, respectively.

8. The method of claim 1, further including responding with an error message from the second wireless communication transceiver to the first wireless communication transceiver when the second wireless communication transceiver detects an error condition in the data transmission package.

9. A computer readable medium including stored instructions adapted for transferring contact information, comprising:
instructions for compiling contact information relating to one or more wireless communication transceiver users into a data transmission package; and,
instructions for transferring the data transmission package from a first wireless transceiver to a second wireless communication transceiver, on a communications network channel native to the first and second wireless communication transceivers.

10. The computer readable medium of claim 9, wherein the data transmission package includes at least one SMS message.

11. The computer readable medium of claim 9, wherein the data transmission package includes at least one e-mail message.

12. The computer readable medium of claim 8, wherein the contact information includes one or more phone book records.

13. The computer readable medium of claim 12, wherein the second wireless communication transceiver extracts the one or more phone book records from the data transmission package and stores the one or more phone book records in a phone book in the second wireless communication transceiver

14. The computer readable medium of claim 11, wherein the one or more phone book records includes at least a name and an associated phone number.

15. The computer readable medium of claim 9, further including instructions for transferring the data transmission package while a first user communicates with a second user via the first wireless communication transceiver and the second wireless communication transceiver, respectively.

16. The computer readable medium of claim 9, further including instructions for transferring the data transmission package after a communication session between a first user and a second user of the first wireless communication transceiver and the second wireless communication transceiver, respectively.

17. The computer readable medium of claim 9, further including instructions for responding with an error message from the second wireless communication transceiver to the first wireless communication transceiver when the second wireless communication transceiver detects an error condition in the data transmission package.

18. The computer readable medium of claim 9, wherein at least one of the first and second communication transceivers is a cell phone.

19. The computer readable medium of claim 9, wherein at least one of the first and second communication transceivers is a PCS device.

20. A method of transferring phone book records, comprising:
compiling one or more fields from at least one phone book into an SMS message; and,
sending the SMS message from a first cell phone to a second cell phone, on a communications network channel native to the first and second cell phones.

21. A method of transferring phone book records, comprising:
compiling one or more fields from at least one phone book into an e-mail message; and,
sending the e-mail message from a first cell phone to a second cell phone, on a communications network channel native to the first and second cell phones.
